(19) United States
(12) Patent Application Publication
(10) Pub. No.: US 2020/0104819 A1
(43) Pub. Date: Apr. 2, 2020

(54) METHODS OF BLOCKCHAIN-BASED TRANSACTIONS

(71) Applicant: UULALA, Ontario, CA (US)

(72) Inventor: Oscar GARCIA, Ontario, CA (US)

(21) Appl. No.: 16/588,625

(22) Filed: Sep. 30, 2019

Related U.S. Application Data
(60) Provisional application No. 62/739,050, filed on Sep. 28, 2018.
(60) Provisional application No. 62/739,056, filed on Sep. 28, 2018.
(60) Provisional application No. 62/739,058, filed on Sep. 28, 2018.

(51) Int. Cl. G06Q 20/24; G06Q 20/10

(52) U.S. Cl. CPC G06Q 20/24; G06F 21/36; G06Q 20/10

(57) ABSTRACT

According to a first embodiment, a method may include receiving, by a user equipment, at least one country-specific interest rate from a transfer entity. The method may further include receiving, by the user equipment, at least one selection of an offer amount, category of product, and/or repayment terms and conditions. The method may further include receiving, by the user equipment, at least one selection of an offer amount, category of product, and/or repayment terms and conditions.

### CROSS REFERENCE TO RELATED APPLICATION

This application claims the benefit of U.S. Provisional Application Nos. 62/739,050, 62/739,056, and 62/739,058, all filed on Sep. 28, 2018. The entire content of the above-referenced applications are hereby incorporated by reference.

### BACKGROUND

### Field

Certain embodiments may relate to blockchain transactions. For example, some embodiments may relate to credit lines entered into blockchain ledgers.

### Description of the Related Art

Blockchain-based transactions have emerged as a form of electronic banking Each party associated with a blockchain has access to the entire database and its complete history. No single party controls the data or the information. Every party can verify the records of its transaction partners directly without an intermediary. Every transaction and its associated value is visible to anyone with access to the system. Each node, or user, on a blockchain has a unique 30-plus-character alphanumeric address that identifies it. Users can choose to remain anonymous or provide proof of their identity to others, and transactions occur between blockchain addresses.

However, one of the challenges with conventional blockchain-based transactions is the one-to-many relationship between users, and the requirement for credit applications to be completed before transactions are permitted. Thus, it is desirable to provide a one-to-one relationship between users that allows the user to be qualified before visiting a merchant location, while also eliminating the need for a credit application. In addition, conventional blockchain-based transactions are associated with an extended period of time that deposited funds are unavailable for use. As a result, it is desirable to provide near instant access to deposited funds while maintaining the flexibility and convenience of blockchain-based transactions.

### BRIEF DESCRIPTION OF THE DRAWINGS

For proper understanding of this disclosure, reference should be made to the accompanying drawings, wherein:

FIG. 1 illustrates a signaling diagram according to certain embodiments.

FIG. 2 illustrates an example of a method performed by user equipment according to certain embodiments.

FIG. 3 illustrates an example of a method performed by a transfer entity according to certain embodiments.

FIG. 4 illustrates an example of a method performed by a network entity according to certain embodiments.

FIG. 5 illustrates another signaling diagram according to certain embodiments.

FIG. 6 illustrates an example of another method performed by user equipment according to certain embodiments.

FIG. 7 illustrates an example of another method performed by a transfer entity according to certain embodiments.

FIG. 8 illustrates an example of another method performed by a network entity according to certain embodiments.

FIG. 9 illustrates another signaling diagram according to certain embodiments.

FIG. 10 illustrates an example of another method performed by user equipment according to certain embodiments.

FIG. 11 illustrates an example of another method performed by a transfer entity according to certain embodiments.

FIG. 12 illustrates an example of another method performed by a network entity according to certain embodiments.

FIG. 13 illustrates an example of a system according to certain embodiments.

### DETAILED DESCRIPTION

Certain embodiments described herein may have various benefits and/or advantages by providing improved security and flexibility for blockchain-based transactions. For example, some embodiments may enable a blockchain, such as a multi-chain blockchain, ledger to manage credit lines. In addition, some embodiments may incorporate a scanned code to provide an additional layer of security and authorization, as well as using a blockchain, such as a multi-chain blockchain, ledger to manage credit lines. In addition, certain embodiments may enable a user to complete credit-based transactions without completing credit applications with individual merchants Certain embodiments are, therefore, directed to improvements in computer-related technology.

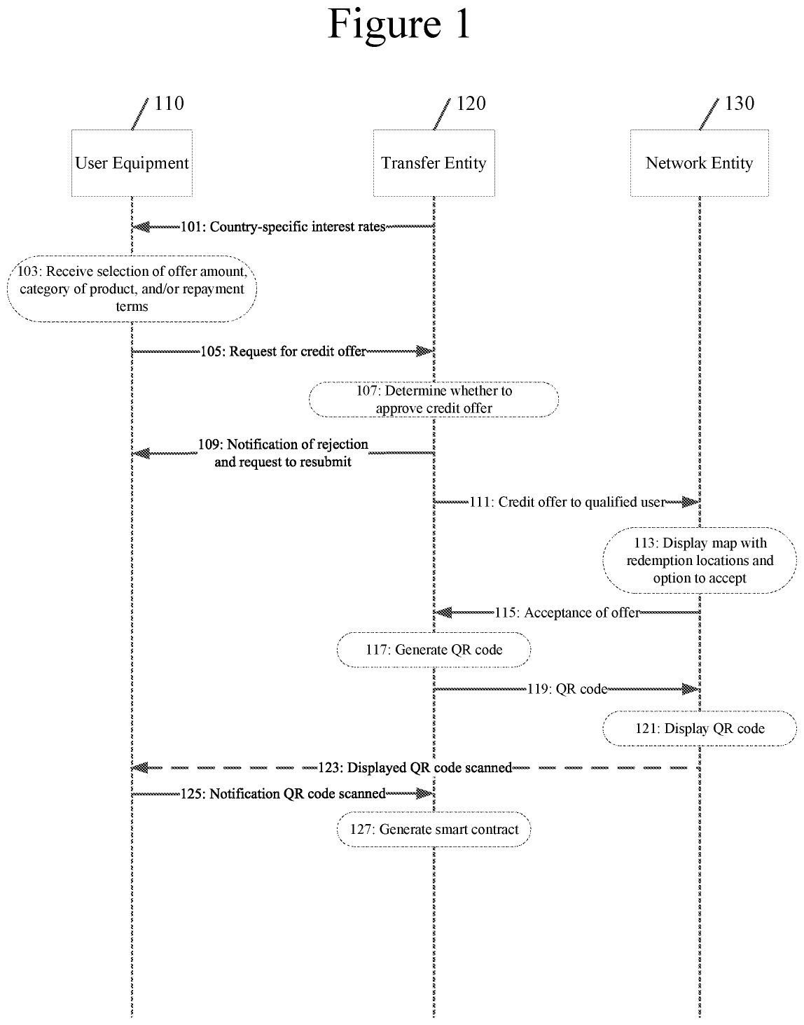

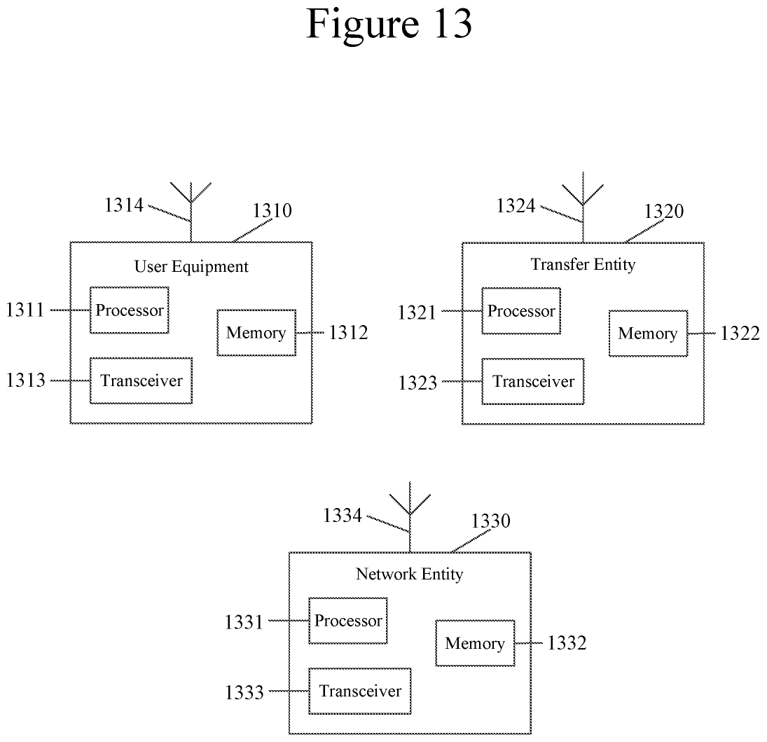

FIG. 1 illustrates an example of a signalling diagram according to some embodiments. User equipment (UE) 110 may be similar to UE 1310 in FIG. 13, transfer entity (TE) 120 may be similar to TE 1320 in FIG. 13, and network entity (NE) 130 may be similar to NE 1330 in FIG. 13. Although only a single UE, TE, and NE are illustrated, a communications network may contain one or more of each of these entities.

In step 101, UE 110 may receive at least one country-specific interest rate from TE 120. In step 103, UE 110 may receive at least one selection of an offer amount, category of product, and/or repayment terms and conditions. UE 110 may allow modification of certain repayment terms and conditions, such as payment, but may not allow modification of all terms and conditions.

In some embodiments, a credit score may be used to determine repayment terms and conditions available to UE 110. For example, TE 120 may report to external Fair Isaac Corporation (FICO) score companies, such as Equifax, Experian, and TransUnion. Furthermore, TE 120 may use an internal ranking system to provide UE 110 with access to more credit lines or offers, which may be based on factors such as level of transaction activity, balance amounts, etc.

In step 105, UE 110 may transmit at least one request for at least one credit offer to TE 120. In step 107, TE 120 may determine whether to approve or deny the received at least one credit offer.

In step 109, upon determining that the received at least one credit offer is unapproved, TE 120 may transmit at least one notification to UE 110 associated with the denial of the request and/or a request to resubmit a second request.

In step 111, upon determining that the received at least one credit offer is approved, TE 120 may transmit at least one credit offer to at least one qualified user, such as NE 130. In some embodiments, the number of offers transmitted to NE 130 may be associated with the internal credit score of NE 130.

In some embodiments, TE 120 may determine whether at least one user is qualified based upon one or more criteria. For example, the determination may be based on whether a user's average account balance meets a threshold, for example, at least 120%, of the offer in the preceding, for example, three months.

In various embodiments, the at least one credit offer may be associated with one or more criteria. For example, an offer timeframe for repayment may be no more than the length of time that the user's account has been opened on the system, but this requirement may be waived if a user opens their account with a threshold amount of money and/or if the user's payroll is directly deposited into the system by their HR department/company.

In step 113, NE 130 may display a map with at least one redemption location and/or at least one option for accepting the at least one credit offer directly on NE 130.

In some embodiments, at least one purchase history associated with UE 110 may be logged into a blockchain, such as a multi-chain blockchain (MCBC), ledger for each country associated with each user. In addition, each purchase transaction may be verified in the MCBC ledger. Furthermore, TE 120 may use various accounting methods in processing the MCBC ledger, such as triple entry accounting. In certain embodiments, TE 120 may retrieve data from the MCBC ledger and/or provide a truncated version to vendors, such as NE 130.

In step 115, NE 130 may transmit at least one acceptance of at least one offer to TE 120. In step 117, TE 120 may generate at least one quick response (QR) code. In step 119, TE 120 may transmit the at least one QR code to NE 130. In step 121, TE 120 may display the at least one QR code. In step 123, UE 110 may scan the at least one QR code displayed by NE 130. In step 125, UE 110 may transmit at least one notification to TE 120 indicating that at least one QR code has been scanned.

In step 127, TE 120 may generate at least one smart contract. In some embodiments, based on a timeframe for repayment, each time NE 130 receives money through the system, the smart contract may be evaluated to determine if a payment is due, and if so, such payment may be automatically deducted from the amount received. TE 120 may record the transaction in the blockchain, such as a multi-chain blockchain (MCBC), ledger to show repayment.

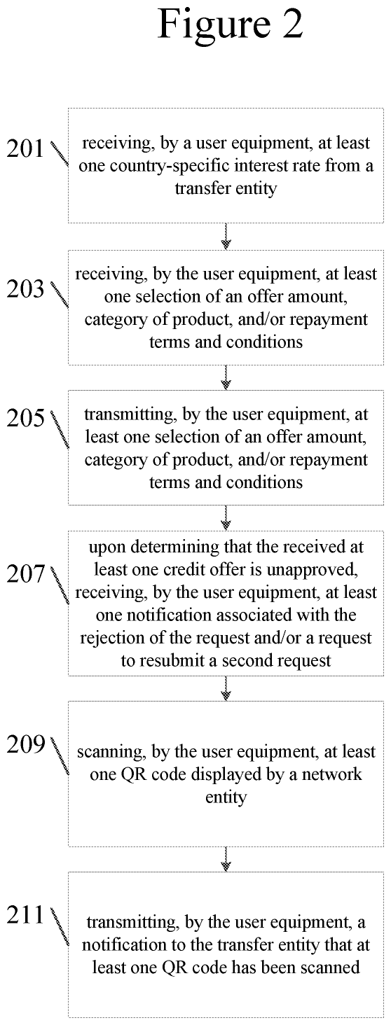

FIG. 2 illustrates an example of a method performed by a user equipment, for example, user equipment 1310 in FIG. 13. In step 201, the user equipment may receive at least one country-specific interest rate from a transfer entity, such as TE 1320 in FIG. 13. In step 203, the user equipment may receive at least one selection of an offer amount, category of product, and/or repayment terms and conditions. In step 205, the user equipment may transmit at least one selection of an offer amount, category of product, and/or repayment terms and conditions. In step 207, the user equipment may, upon determining that the received at least one credit offer is unapproved, receive, by the user equipment, at least one notification associated with the rejection of the request and/or a request to resubmit a second request. In step 209, the user equipment may scan at least one QR code displayed by a network entity, such as NE 1330 in FIG. 13. In step 211, the user equipment may transmit at least one notification to the transfer entity indicating that at least one QR code has been scanned.

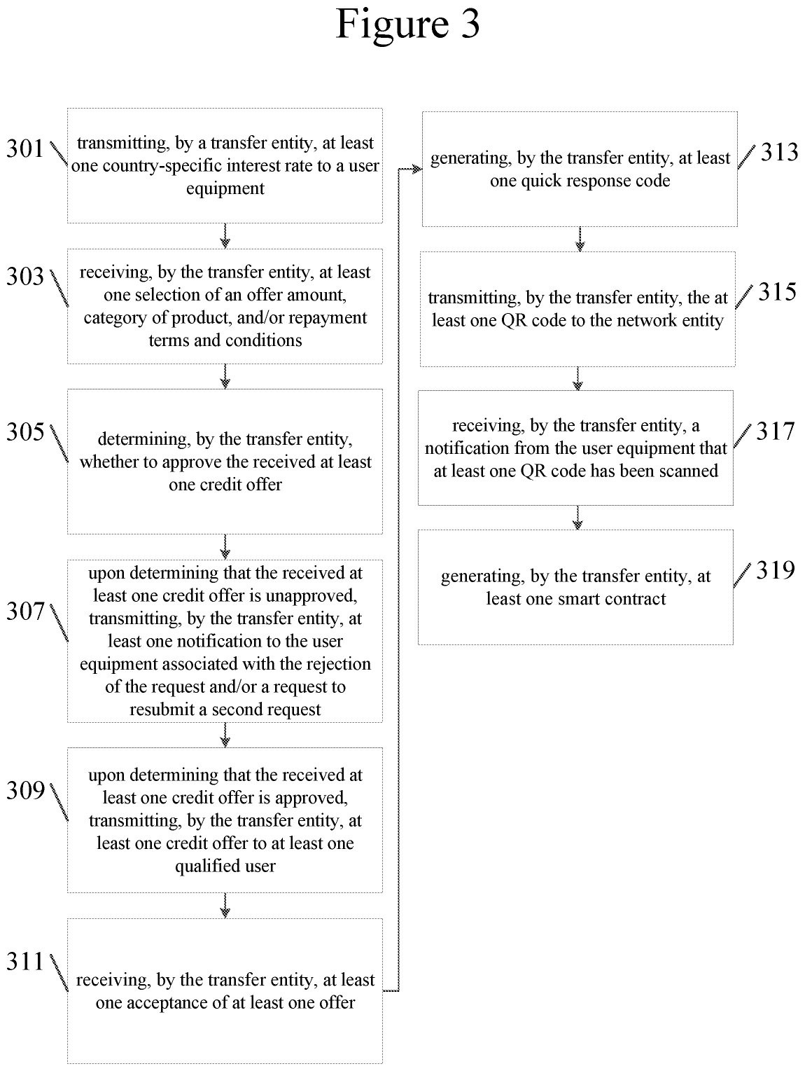

FIG. 3 illustrates an example of a method performed by a transfer entity, for example, transfer entity 1320 in FIG. 13. In step 301, the transfer entity may at least one country-specific interest rate to a user equipment, for example, UE 1310 in FIG. 13. In step 303, the transfer entity may receive at least one selection of an offer amount, category of product, and/or repayment terms and conditions. In step 305, the transfer entity may determine whether to approve or reject the received at least one credit offer. In step 307, the transfer entity may, upon determining that the received at least one credit offer is unapproved, transmit at least one notification to the user equipment associated with the rejection of the request and/or a request to resubmit a second request. In step 309, the transfer entity may, upon determining that the received at least one credit offer is approved, transmit at least one credit offer to at least one qualified user. In step 311, the transfer entity may receive at least one acceptance of at least one offer. In step 313, the transfer entity may generate at least one quick response code. In step 315, the transfer entity may transmit the at least one QR code to at least one network entity, for example, NE 1330 in FIG. 13. In step 317, the transfer entity may receive a notification from the user equipment that at least one QR code has been scanned. In step 319, the transfer entity may generate at least one smart contract. Additionally or alternatively, the transfer entity may display terms and conditions of the at least one credit offer, wherein the transfer entity may be configured to detect an acceptance or rejection from the user of the terms and conditions of the at least one credit offer.

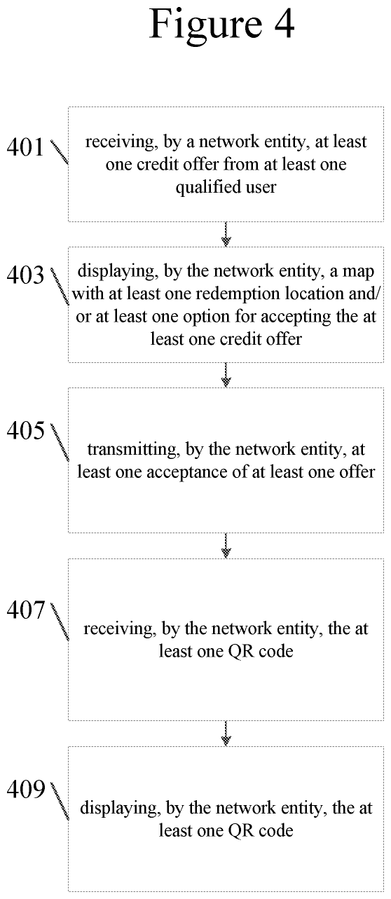

FIG. 4 illustrates an example of a method performed by a network entity, for example, network entity 1330 in FIG. 13. In step 401, the transfer entity may receive at least one credit offer from at least one qualified user. In step 403, the transfer entity may display a map with at least one redemption location and/or at least one option for accepting the at least one credit offer. In step 405, the network entity may transfer at least one acceptance of at least one offer. In step 407, the network entity may receive the at least one QR code. In step 409, the network entity may display the at least one QR code.

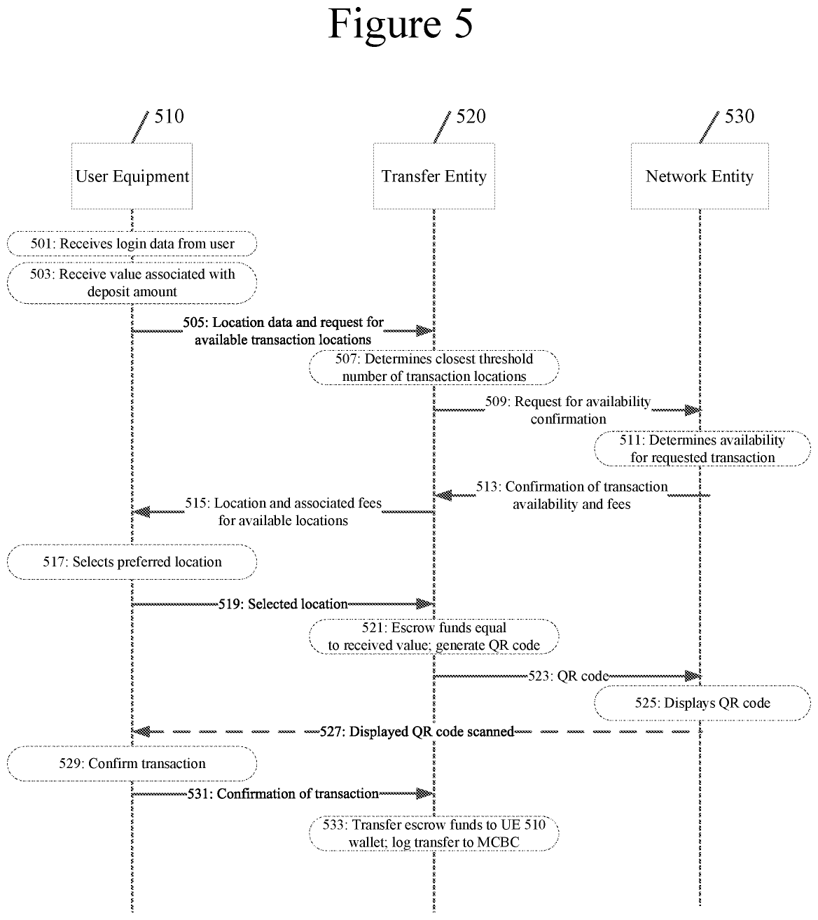

FIG. 5 illustrates an example of a signalling diagram according to some embodiments. User equipment (UE) 510 may be similar to UE 1310 in FIG. 13, transfer entity (TE) 520 may be similar to TE 1320 in FIG. 13, and network entity (NE) 530 may be similar to NE 1330 in FIG. 13. Although only a single UE, TE, and NE are illustrated, a communications network may contain one or more of each of these entities.

In step 501, UE 510 may receive login data from a user. In some embodiments, the login data may comprise one or more of a user name, an email address, and/or a password. The login data may be used to create a new account with TE 520. Alternatively, the login data may be used for a validation process with TE 520, where the login data is associated with an existing account identifier and/or hash. For example, the hash may be associated with a blockchain, such as a multi-chain blockchain (MCBC) uniform resource locator (URL) tag of a digital wallet.

In step 503, UE 510 may receive a value associated with a deposit amount from the user, and/or may receive location information. In step 505, UE 510 may transmit location data associated with UE 510, the received value associated with a deposit amount, and/or at least one request for available transaction locations to TE 520.

In step 507, TE 520 may determine a threshold number of transaction entities based upon at least one correlation criteria between a location associated with each of one or more transaction entities and the received location data. For example, the correlation criteria may include one or more of maximum distance from the received location data, operating hours, and/or at least one maximum fee.

In step 509, TE 520 may transmit at least one request for confirmation of availability to provide the requested transaction to one or more network entities satisfying the correlation criteria, for example, NE 530. In step 511, NE 530 may determine its availability for the requested transaction. One or more additional network entities may perform this step.

In step 513, upon determining that NE 530 is available to provide the requested transaction, NE 530 may transmit a confirmation of availability for the transaction to TE 520. In addition, in some embodiments, NE 530 may transmit at least one fee value associated with the requested transaction to TE 520. However, one or more additional network entities may perform these steps, as well.

In step 515, TE 520 may transmit the received at least one location and at least one fee associated with the requested transaction for each network entity that transmits data in the previous step. In step 517, UE 510 may receive at least one selection of at least one intended recipient of funds and/or at least one location of the at least one received location. In some embodiments, UE 510 receiving at least one selection of at least one intended recipient of funds and/or at least one location of the at least one received location may initiate at least one payment transaction.

In step 519, UE 510 may transmit the at least one intended recipient of funds and/or selected location to TE 520. In step 521, TE 520 may deposit funds associated with NE 530 into escrow equal to the received value associated with a deposit amount. For example, TE 520 may escrow a token percentage up to a certain threshold, such as 0.25 cents, from one of one or more buckets, such as private wallet access, trading wallet access, and reserve wallets to load a transaction onto the MCBC. In some embodiments, TE 520 may also generate a quick response (QR) code. In some embodiments, the QR code may be associated with an account identifier and/or a MCBC URL tag, for example, the account identifier and MCBC URL tag associated with UE 510. Upon completion of the transaction, transactional metadata is stored on a blockchain-based ledger to create a record of transaction for credit profile of the user.

In step 523, TE 520 may transmit the QR code to NE 530. In some embodiments, TE 520 may transmit the QR code to UE 510, and, upon its receipt, UE 510 may transmit the QR code to NE 530. For example, NE 530 may be associated with a contact list of UE 510, and/or UE 510 may transmit the QR code to NE 130 based upon an email address in a contact list associated with NE 530.

In step 525, NE 530 may display the received QR code. In step 527, UE 510 may scan the QR code displayed by NE 530. In step 529, UE 510 may receive a transaction confirmation from the user. In step 531, UE 510 may transmit a confirmation of the transaction to TE 520.

In step 533, TE 520 may transfer the funds in escrow to an account associated with UE 510. In some embodiments, TE 520 may log the transfer to a blockchain, such as a multi-chain blockchain (MCBC) ledger according to a transaction identifier. For example, transactional metadata may be stored on the MCBC ledger configured for the user to establish at least one credit profile. In addition, the transaction may be escrowed and/or tracked to its full completion, and/or may be logged into the MCBC.

In some embodiments, TE 520 may place at least one restriction on future transactions between UE 510 and TE 530, for example, for a threshold period of time, such as 10 years.

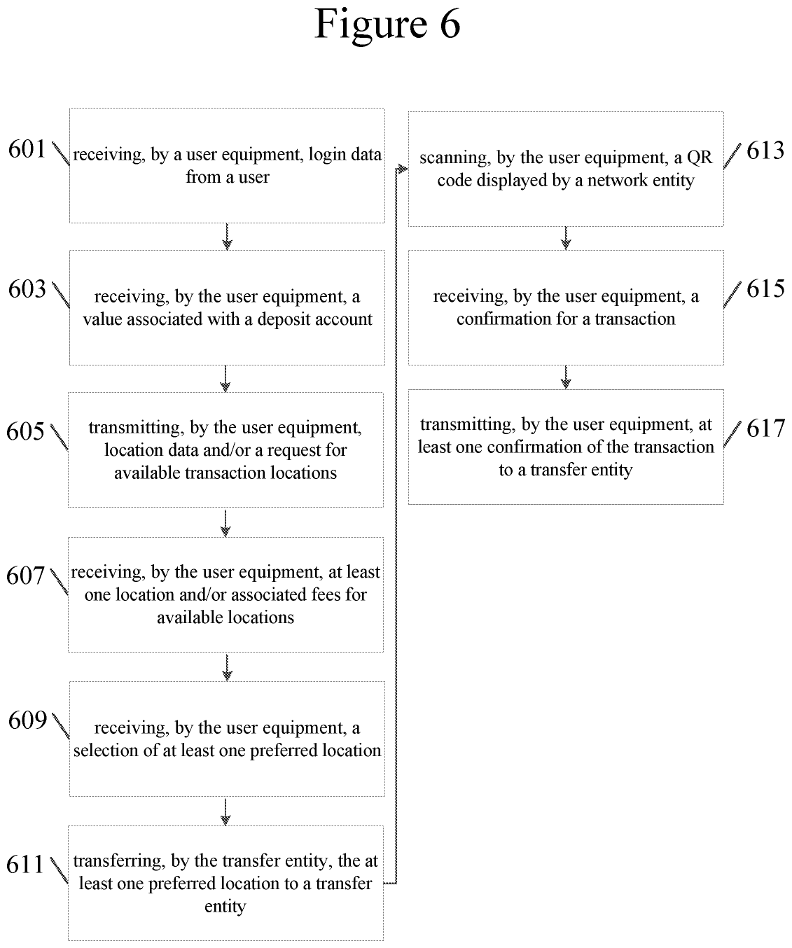

FIG. 6 illustrates an example of a method performed by a user equipment, for example, user equipment 1310 in FIG. 13. In step 601, the user equipment may receive login data from a user. In step 603, the user equipment may receive a value associated with a deposit account. In step 605, the user equipment may transmit location data and/or a request for available transaction locations. In step 607, the user equipment may receive at least one location and/or associated fees for available locations. In step 609, the user equipment may receive a selection of at least one intended recipient of funds and/or of at least one preferred location. In some embodiments, the user equipment receiving at least one selection of at least one intended recipient of funds and/or at least one location of the at least one received location may initiate at least one payment transaction. In step 611, the user equipment may transmit the at least one intended recipient of funds and/or at least one preferred location to a transfer entity. In step 613, the user equipment may scan a QR code displayed by a network entity. In step 615, the user equipment may receive a confirmation for a transaction. In step 617, the user equipment may transmit at least one confirmation of the transaction to a transfer entity.

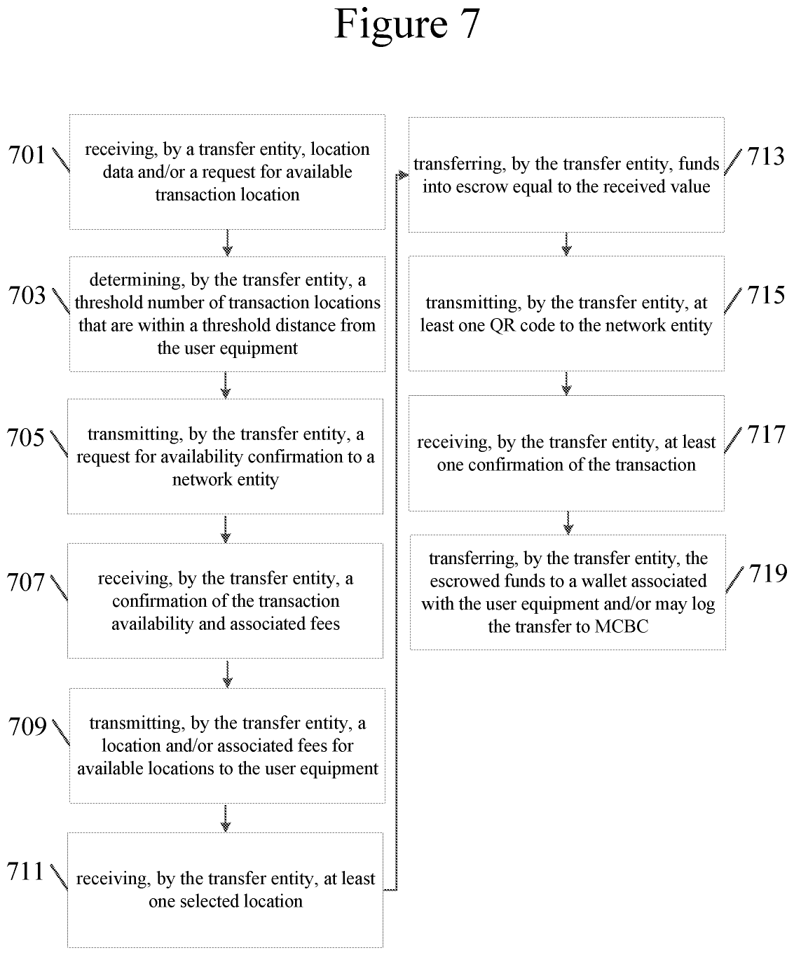

FIG. 7 illustrates an example of a method performed by a transfer entity, for example, transfer entity 1320 in FIG. 13. In step 701, the transfer entity may receive location data and/or a request for available transaction location. In step 703, the transfer entity may determine a threshold number of transaction locations that are within a threshold distance from the user equipment. In step 705, the transfer entity may transmit a request for availability confirmation to a network entity. In step 707, the transfer entity may receive a confirmation of the transaction availability and associated fees. In step 709, the transfer entity may transmit a location and/or associated fees for available locations to the user equipment. In step 711, the transfer entity may receive at least one selected location. In step 713, the transfer entity may deposit funds into escrow equal to the received value. In step 715, the transfer entity may transmit at least one QR code to the network entity. In step 717, the transfer entity may receive at least one confirmation of the transaction. In step 719, the transfer entity may transfer the escrowed funds to a wallet associated with the user equipment and/or may log the transfer to MCBC.

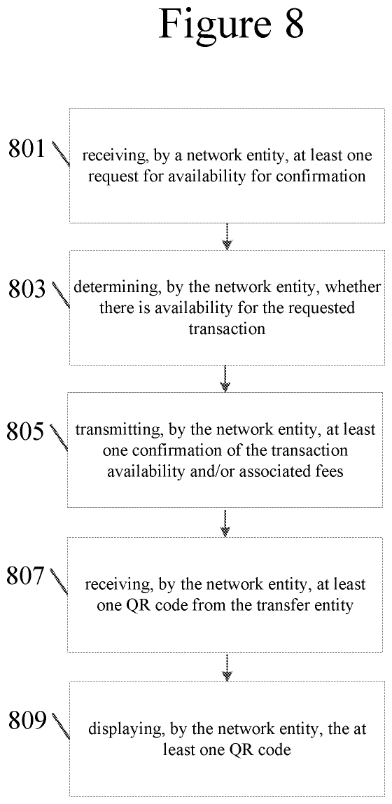

FIG. 8 illustrates an example of a method performed by a network entity, for example, network entity 1330 in FIG. 13. In step 801, the network entity may receive at least one request for availability for confirmation. In step 803, the network entity may determine whether there is availability for the requested transaction. In step 805, the network entity may transmit at least one confirmation of the transaction availability and/or associated fees. In step 807, the network entity may receive at least one QR code from the transfer entity. In step 809, the network entity may display the at least one QR code.

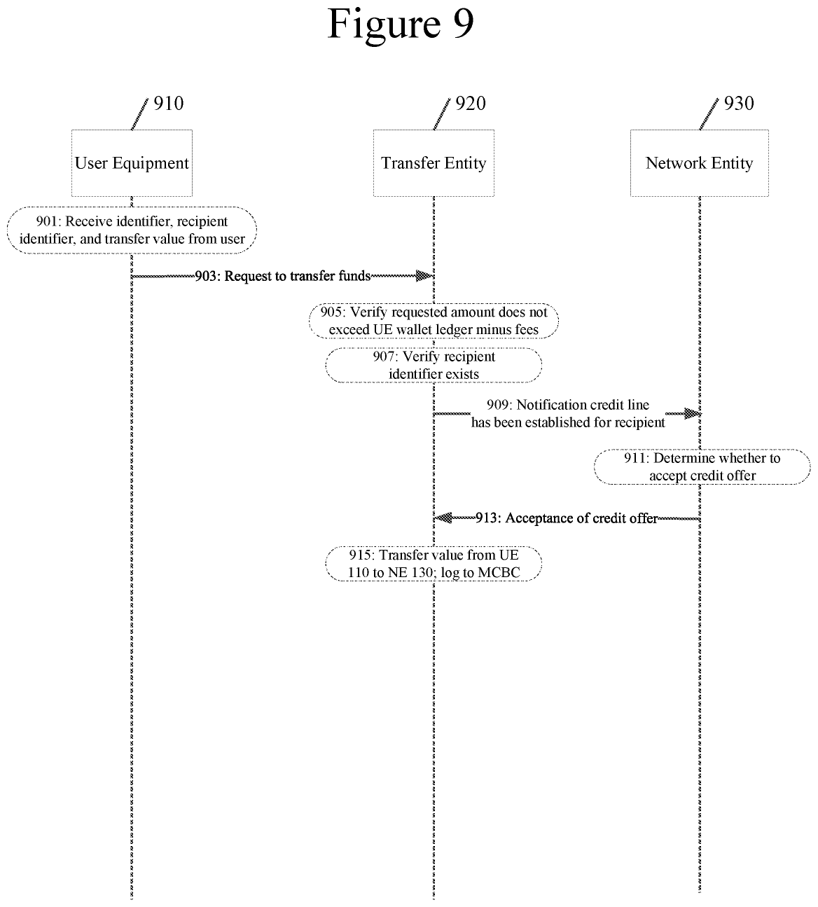

FIG. 9 illustrates an example of a signalling diagram according to some embodiments. User equipment (UE) 910 may be similar to UE 1310 in FIG. 13, transfer entity (TE) 920 may be similar to TE 1320 in FIG. 13, and network entity (NE) 930 may be similar to NE 1330 in FIG. 13. Although only a single UE, TE, and NE are illustrated, a communications network may contain one or more of each of these entities. In some embodiments, UE 910, TE 920, and/or NE 930 may reside in different countries.

In step 901, TE 920 may receive at least one user identifier, at least one recipient identifier, and/or at least one transfer value from user equipment 910. In some embodiments, the user identifier and/or recipient identifier may comprise one or more of a user name, an email address, and/or a password. The user identifier may be used to create a new account with TE 920, or may be used for a validation process with TE 920, where the login data is associated with an existing account identifier and/or hash. For example, the hash may be associated with a blockchain, such as a multi-chain blockchain (MCBC), uniform resource locator (URL) tag of a digital wallet.

In step 903, UE 910 may transmit a request to transfer funds to TE 920. In some embodiments, the request may also include the at least one user identifier, at least one recipient identifier, and/or at least one transfer value.

In step 905, TE 920 may verify that the at least one transfer value does not exceed a value associated with UE 910 in a blockchain, such as a multi-chain blockchain (MCBC), ledger. In some embodiments, TE 920 may subtract fees associated with transferring funds to NE 930 from the value associated with UE 910 in a blockchain wallet before determining that the at least one transfer value is not exceeded.

In step 907, TE 920 may verify whether the at least one recipient identifier exists in the MCBC ledger. In step 909, TE 920 may transmit at least one notification to NE 930 that a credit line is available to be established for NE 930. If TE 920 determined in step 907 that the at least one recipient identifier does not exist in the MCBC ledger, the at least one notification may contain data for creating an account associated with the MCBC ledger.

In step 911, NE 930 may display information associated with determining whether to accept the credit line offer. In some embodiments, if the at least one notification comprised a notification for creating an account in the MCBC ledger, NE 930 may also collect personal data for creating an account associated with the MCBC ledger.

In step 913, upon determining to accept the credit line offer, NE 930 may transmit an indication to TE 920 of acceptance of the credit line offer. The indication may also contain personal data for creating an account in the MCBC ledger.

In step 915, upon receiving the acceptance of the credit line offer from NE 930, TE 920 may modify the MCBC ledger to transfer value from UE 910 to NE 930 equal to the at least one transfer value.

In some embodiments, TE 920 may reconcile balances for at least one account, such as UE 910 and NE 930, every threshold number of days, such as 5 days.

In some embodiments, NE 930 may transfer the credit line to at least one bank, pick up cash through a partner, use a virtual credit card, and/or request a physical credit card. Furthermore, in embodiments where NE 930 picks up cash through a partner, TE 920 may transmit a sequence number and/or a second QR code to UE 910 to be scanned by NE 930. In addition, NE 930 may split the credit line among a plurality of multiple locations.

In some embodiments, at least a portion of the fee determined in step 905 may be used to purchase at least a portion of at least one token to log the transaction into the MCBC.

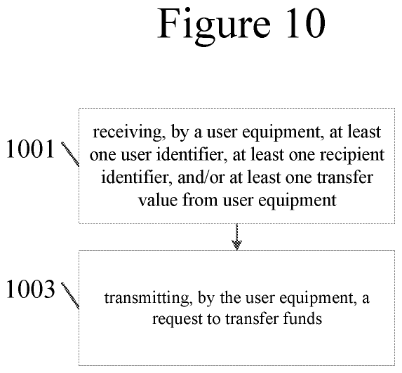

FIG. 10 illustrates an example of a method performed by a user equipment, for example, user equipment 1310 in FIG. 13. In step 1001, the user equipment may receive at least one user identifier, at least one recipient identifier, and/or at least one transfer value from user equipment. In step 1003, the user equipment may transmit a request to transfer funds.

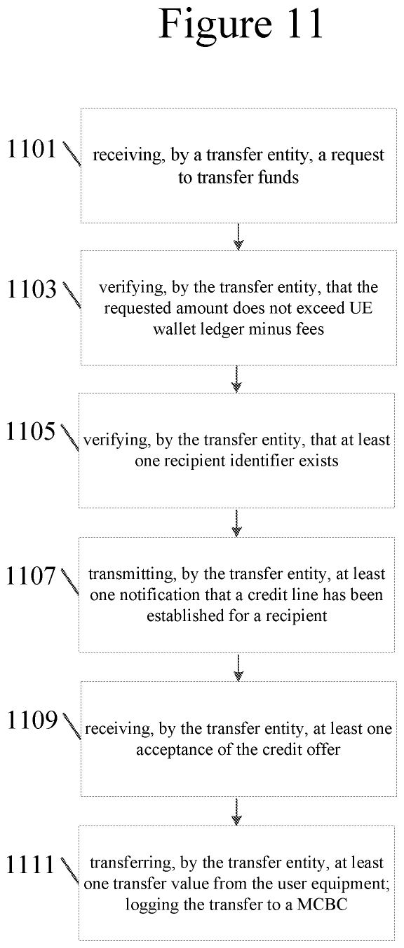

FIG. 11 illustrates an example of a method performed by a transfer entity, for example, transfer entity 1320 in FIG. 13. In step 1101, the transfer entity may receive a request to transfer funds. In step 1103, the transfer entity may verify that the requested amount does not exceed UE wallet ledger minus fees. In step 1105, the transfer entity may verify that at least one recipient identifier exists. In step 1107, the transfer entity may transmit at least one notification that a credit line has been established for a recipient. In step 1109, the transfer entity may receive at least one acceptance of the credit offer. In step 1111, the transfer entity may transfer at least one transfer value from the user equipment; logging the transfer to a MCBC.

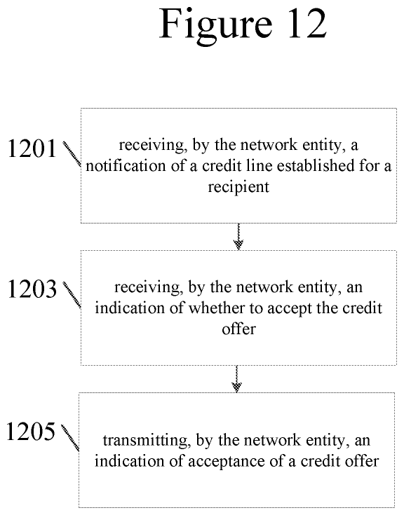

FIG. 12 illustrates an example of a method performed by a network entity, for example, network entity 1330 in FIG. 13. In step 1201, the network entity may receive a notification of a credit line established for a recipient. In step 1203, the network entity may receive an indication of whether to accept the credit offer. In step 1205, the network entity may transmit an indication of acceptance of a credit offer.

FIG. 13 illustrates an example of a system according to certain embodiments. In one embodiment, a system may include multiple devices, such as, for example, user equipment 1310, transfer entity 1320, and network entity 1330. User equipment 1310 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

Transfer entity 1320 may be one or more servers. Network entity 1330 may be one or more of a kiosk, a vendor, and/or another user equipment.

One or more of these devices may include at least one processor, respectively indicated as 1311, 1321, and 1331. At least one memory may be provided in one or more of devices indicated at 1312, 1322, and 1332. The memory may be fixed or removable. The memory may include computer program instructions or computer code contained therein, and/or any physics statistics conceptual link. Processors 1311, 1321, and 1331 and memory 1312, 13, and 1332 or a subset thereof, may be configured to provide means corresponding to the various blocks of FIGS. 1-12. Although not shown, the devices may also include positioning hardware, such as global positioning system (GPS) or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 13, transceivers 1313, 1323, and 1333 may be provided, and one or more devices may also include at least one antenna, respectively illustrated as 1314, 1324, and 1334. The device may have many antennas, such as an array of antennas configured for multiple input multiple output (MIMO) communications, or multiple antennas for multiple radio access technologies. Other configurations of these devices, for example, may be provided.

Transceivers 1313, 1323, and 1333 may be a transmitter, a receiver, or both a transmitter and a receiver, or a unit or device that may be configured both for transmission and reception.

Processors 1311, 1321, and 1331 may be embodied by any computational or data processing device, such as a central processing unit (CPU), application specific integrated circuit (ASIC), or comparable device. The processors may be implemented as a single controller, or a plurality of controllers or processors.

Memory 1312, 1322, and 1332 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language. Memory may be removable or non-removable.

The memory and the computer program instructions may be configured, with the processor for the particular device, to cause a hardware apparatus such as user equipment to perform any of the processes described below (see, for example, FIGS. 1-12). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 1-12. For example, circuitry may be hardware-only circuit implementations, such as analog and/or digital circuitry. In another example, circuitry may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that certain embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

FICO Fair Issac Corporation
GPS Global Positioning System
MCBC Multi-Chain Blockchain
MEMS Micro Electrical Mechanical System
NE Network Entity
PDA Personal Digital Assistant
QR Quick Response
TE Transfer Entity
UE User Equipment
URL Uniform Resource Locator

We claim:

1. A method, comprising:
receiving, by a transfer entity, at least one selection of an offer amount, category of product, and/or repayment terms and conditions;
determining, by the transfer entity, whether to approve the received at least one credit offer; and
upon determining that the received at least one credit offer is approved, transmitting, by the transfer entity, at least one credit offer to at least one qualified user.

2. The method of claim 1, further comprising:
transmitting, by the transfer entity, at least one country-specific interest rate to a user equipment.

3. The method of claim 1, further comprising:
upon determining that the received at least one credit offer is unapproved, transmitting, by the transfer entity, at least one notification to the user equipment associated with the rejection of the request and/or a request to resubmit a second request.

4. The method of claim 1, further comprising:
receiving, by the transfer entity, at least one acceptance of at least one offer.

5. The method of claim 1, further comprising:
generating, by the transfer entity, at least one quick response code.

6. The method of claim 1, further comprising:
transmitting, by the transfer entity, the at least one QR code to the network entity.

7. The method of claim 1, further comprising:
receiving, by the transfer entity, a notification from the user equipment that at least one QR code has been scanned.

8. The method of claim 1, further comprising:
generating, by the transfer entity, at least one smart contract.

9. A method, comprising:
transmitting, by a transfer entity, a request for availability confirmation to a network entity;
transferring, by the transfer entity, tokens into escrow equal to the received value; and
transferring, by the transfer entity, tokens into escrow equal to the received value.

10. The method of claim 9, further comprising:
receiving, by the transfer entity, location data and/or a request for available transaction location.

11. The method of claim 9, further comprising:
determining, by the transfer entity, a threshold number of transaction locations that are within a threshold distance from the user equipment.

12. The method of claim 9, further comprising:
receiving, by the transfer entity, a confirmation of the transaction availability and associated fees.

13. The method of claim 9, further comprising:
transmitting, by the transfer entity, a location and/or associated fees for available locations to the user equipment.

14. The method of claim 9, further comprising:
receiving, by the transfer entity, at least one selected location.

15. The method of claim 9, further comprising:
transmitting, by the transfer entity, at least one QR code to the network entity.

16. The method of claim 9, further comprising:
receiving, by the transfer entity, at least one confirmation of the transaction.

17. A method, comprising:
verifying, by a transfer entity, that the requested amount does not exceed UE wallet ledger minus fees;
verifying, by the transfer entity, that at least one recipient identifier exists; and
transferring, by the transfer entity, at least one transfer value from a user equipment.

18. The method of claim 17, further comprising:
receiving, by the transfer entity, a request to transfer funds.

19. The method of claim 17, further comprising:
transmitting, by the transfer entity, at least one notification that a credit line has been established for a recipient.

20. The method of claim 17, further comprising:
receiving, by the transfer entity, at least one acceptance of the credit offer.
